(19) United States
(12) Patent Application Publication
(10) Pub. No.: US 2023/0228986 A1
(43) Pub. Date: Jul. 20, 2023

(54) LINE SCANNER DRIVEN BY MAGNETICALLY PRELOADED CAM

(71) Applicant: Light Steering Technologies, Inc., Manchester, NH (US)

(72) Inventors: Vladimir G. Krylov, Brookline, NH (US); Aaron R. Castillo, Nashua, NH (US); Christopher C. Chagaris, Manchester, NH (US)

(73) Assignee: Light Steering Technologies, Inc., Mancehster, NH (US)

(21) Appl. No.: 18/155,864

(22) Filed: Jan. 18, 2023

Related U.S. Application Data
(60) Provisional application No. 63/301,306, filed on Jan. 20, 2022.

(51) Int. Cl. G02B 26/10; G02B 26/08; G02B 7/182; H01F 7/02; F16C 11/04; F16H 53/06; F16H 53/04

(52) U.S. Cl. CPC G02B 26/101; F16C 11/04; F16H 53/04; F16H 53/06; G02B 7/1828; G02B 26/0816; H01F 7/0221; F16C 2202/42; F16C 2204/42

(57) ABSTRACT

A line scanner assembly includes a cam with a cam surface, where the cam rotatable about a cam axis of rotation and includes a first ferromagnetic material. A mirror with a planar surface is configured to tilt about a mirror axis of rotation. A follower is attached to the mirror and has a second ferromagnetic material, where the first magnetic material and/or the second magnetic material includes a permanent magnet and where the follower maintains contact with the cam due to a magnetic attraction between the first ferromagnetic material and the second ferromagnetic material.

### RELATED APPLICATIONS

This application claims the benefit under 35 U.S.C. § 119(e) of U.S. Provisional Pat. Application No. 63/301,306, titled LINE SCANNER DRIVEN BY MAGNETICALLY PRELOADED CAM and filed on Jan. 20, 2022, the contents of which are incorporated herein by reference in its entirety

### FIELD OF THE INVENTION

The present disclosure relates generally to optical scanners, and more particularly to optical scanners that mechanically rotate an optical mirror on a single axis in a predefined, repetitive manner to produce a line scan.

### BACKGROUND

Optical systems having systematic periodic scanning are found in barcode readers, Light Detection and Ranging (LIDAR) systems, metrology, and others. In some such applications the scanning is achieved by reflecting the laser beam or optical system’s line-of-sight from a mirror surface, the orientation of which is changed through mechanical means.

Conventional approaches to mechanically changing the orientation of a mirror surface include rotating mirror scanners, polygon scanners, galvanometers, and MEMS mirror scanners. Each approach has its benefits and drawbacks. For example, rotating mirror scanners are simple devices, but they have limited duty cycle since only a fraction of the rotation period is useful for beam reflection. Polygon scanners overcome this limitation by placing several mirror segments on the outer diameter of the rotating component, but this approach increases the cost of the reflector. Galvanometers use an oscillating motion to produce back-and-forth scanning, but such devices require a complex controller with a feedback loop. MEMS mirror scanners are small, well integrated devices, but they are limited in the angular range and aperture size.

A cam is a mechanical linkage that transforms rotary motion into linear motion or oscillating motion and has been used in variety of devices for centuries. A cam requires a follower to be pre-loaded against or maintain contact with the cam. This can be accomplished with a spring to bias the follower into contact with the cam. However, the spring limits the practicality of a cam for optical scanners as requiring minimized mirror deformation and minimized mirror mass in order to be competitive with other scanner technologies mentioned above.

### SUMMARY

The present disclosure is directed to a line scanner assembly that can produce a systematic, periodic, and one-dimensional scan pattern based on the cam geometry and rotation frequency. In accordance with an embodiment of the present disclosure, a line scanner includes a cam and a follower, where the follower is maintained in contact with the cam by magnetic attraction. For example, the cam can be made of a ferromagnetic material and the follower can include or be made of a permanent magnet, or vice versa. In some embodiments, the assembly includes a laterally unconstrained magnetic joint as described in U.S. Pat. Nos. 10,685,771 and 10,830,988, the contents of which are incorporated herein by reference in their entireties. In some such embodiments, the follower maintains point or line contact with the cam throughout a range of motion of the cam.

In one example embodiment, the cam is made from ferromagnetic steel, such as 400 series stainless steel alloy. The follower includes a mirror and a magnet located at the point of contact with the cam such that the magnetic force preloads the cam and the follower. The mirror is secured on a rotational axis, typically at the center of the mirror aperture, while the cam contact point is located near an edge of the mirror. For example, the mirror can have an elliptical shape that pivots about a rotational axis passing through the minor axis of the ellipse, and the magnet is positioned near the edge of the mirror along the major axis of the ellipse. This arrangement can translate rotational motion of the cam into oscillating tilt motion of the mirror.

The angular oscillation range of the mirror depends on the distance between the mirror’s rotational axis and cam axis as well as the eccentricity of the cam. Maximum oscillation frequency depends on the inertial properties of the mirror and attraction force between the magnet and the cam, the latter being the function of the permanent magnet type and magnet and cam geometries. The oscillation profile and dependence of mirror deflection on the cam rotation angle is based on the cam geometry. The simplest cam, being an eccentric circle, produces sinusoidal oscillation profiles; more complex cam geometries can be derived for other scanning profile types.

### BRIEF DESCRIPTION OF THE DRAWINGS

FIG. 1 illustrates a perspective view of showing components of a line scanner assembly, where the mirror is partially cut away to more clearly show the magnet, in accordance with an embodiment of the present disclosure.

FIGS. 2A and 2B illustrate side views of a line scanner with the mirror at minimum and maximum deflection positions, in accordance with embodiments of the present disclosure.

FIG. 3 illustrates a front view of a line scanner having a cam geometry accommodating alignment tolerances between a mirror axis and a cam axis, in accordance with an embodiment of the present disclosure.

FIG. 4 illustrates a perspective view showing components of a line scanner assembly, where the mirror is partially cut away to better show an additional bearing element at the interface with the cam, in accordance with an embodiment of the present disclosure.

FIG. 5 is a plot of scanning profiles supported by possible cam geometries, in accordance with an embodiment of the present disclosure.

The figures depict various embodiments of the present disclosure for purposes of illustration only. Numerous variations, configurations, and other embodiments will be apparent from the following detailed discussion.

### DETAILED DESCRIPTION

Disclosed is an assembly for a line scanner. In accordance with one embodiment, the assembly includes cam with a cam surface, where the cam is rotatable about a cam axis of rotation. The cam is made of or includes ferromagnetic material. The assembly also includes a mirror with a planar surface. The mirror is configured to tilt about a mirror axis of rotation. A magnet assembly is attached to the mirror and makes contact with the cam. The mirror is pre-loaded with the cam due to magnetic attraction between the magnet assembly and the cam. The magnetic preload can eliminate the need for springs that have commonly been used for this purpose, can improve performance, and can reduce power requirements - all considered to be important parameters in the single-axis optical scanning applications having a predefined, repetitive scanning pattern.

The terminology used herein is for the purpose of describing particular embodiments and is not intended to limit the scope of the present disclosure. The term “and/or” includes any and all combinations of one or more of the associated listed items. The singular forms “a”, “an”, and “the” are intended to include the plural forms as well as singular forms, unless the context clearly indicates otherwise. It will be further understood that the terms “comprises” and/or “comprising”, when used in this specification, indicate the presence of stated features, elements, and/or components, but do not preclude the presence or addition of one or more other features, elements, components, and/or groups thereof.

The present disclosure is to be considered an example and is not intended to limit the invention to the specific embodiments illustrated by the figures or description below.

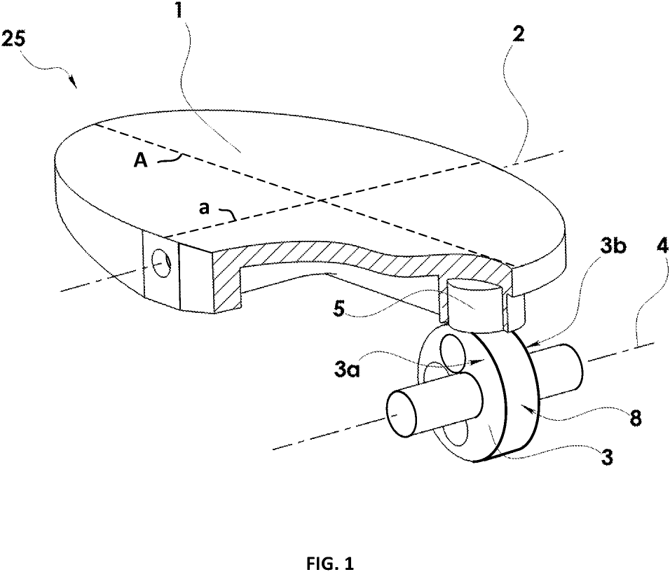

FIG. 1 depicts a perspective view of components of a line scanner 25 that includes a planar front-surface mirror 1, a permanent magnet 5, and a rotating cam 3, in accordance with an embodiment of the present disclosure. The mirror 1 is pivotably mounted on a first rotational axis 2 and has an elliptical shape. The first rotational axis 2 passes through or is parallel to a minor axis a of the ellipse in this example. In one example, the mirror 1 is attached to one or more pins that extend along the first rotational axis 2, where the mirror 1 is secured to the pin(s) and can pivot about the first rotational axis 2 in response to cam movement.

The cam 3 rotates or is capable of rotating about a second rotational axis 4. The cam 3 is made from or includes a ferromagnetic material, such as steel. Driving the cam 3, mounting the mirror, and establishing first and second rotational axes 2, 4, can be performed according to techniques known in the field. For example, the cam 3 can be rotated about the second rotational axis 4 using an electric motor, gear, or other suitable means. The magnet 5 can be fixed to the mirror 1 using an adhesive, fasteners, clamp, or other suitable method, and the mirror positioned to pivot about the first rotational axis 2.

The permanent magnet 5 can be attached to the mirror 1 to create a cam - follower kinematic pair with the cam 3. The magnetic field produced between the permanent magnet 5 and the cam 3 results in magnetic attraction force between these components that is useful to establish and maintain contact between the cam 3 and the permanent magnet 5 throughout the range of the line scanner operating parameters. In this example, the magnet 5 has a cylindrical shape with a planar face positioned in contact with the cam 3. The magnet 5 can have other geometries, including spherical, hemispherical, frustoconical, ovoid, ovoid with a flat face, cuboid, and cuboid with convex face, to name a few examples.

In this example, the cam 3 has an eccentric or ovoid geometry. In other embodiments, the cam 3 is generally cylindrical and can rotate about the second rotational axis that offset from the geometric center of the cam 3, therefore resulting in an eccentric geometry when rotated. In other embodiments, the cam 3 has an oval, elliptical, snail, or other shape suitable to achieve the desired mirror movement. In some embodiments, the cam 3 has no concave regions or other regions that would break tangential contact between the cam 3 and the follower. As also shown in the example of FIG. 1, opposite faces 3a, 3b of the cam 3 are parallel and have the same geometry so that the cam barrel 8 is linear between the faces 3a, 3b. In other embodiments, the cam barrel 8 is domed between the opposite faces 3a, 3b. Numerous variations and embodiments will be apparent in light of the present disclosure.

In some embodiments, the contact between the cam 3 and the magnet 5 is or approximates a single point contact. Such point contact can be achieved between a convex surface (e.g., hemispherical) and a planar surface, or between two convex surfaces, for example. In other embodiments, the contact is line contact. Line contact can be achieved between a planar surface of magnet 5 and a cylindrical surface of cam barrel 8, for example.

As used herein, the term “point contact” generally refers to the smallest possible contact between two continuous surfaces. For ideal surfaces, point contact can be a single atom; however, due to manufacturing limitations, point contact may be greater than a single point. For example, even finely polished smooth surfaces may exhibit grooves, ridges, and facets when viewed at the microscopic level. Also, components in contact with each other may exhibit elastic deformation that enlarges the area of the contact. As such, point contact between two surfaces may include a one or more of such features on one surface making contact with one or more such features on another surface, for example. Thus, the term “point contact” between two surfaces includes a single point in addition to a small localized area of a surface or a plurality of points within a size of up to 1% of the surface area. Similarly, the term “line contact” generally refers to the smallest possible 1-dimensional or linear contact between two continuous surfaces. For ideal surfaces, line contact can be a line of atoms in a 1-dimensional array; however due to manufacturing limitations or elastic material deformation, line contact may be greater than a single line of atoms. For example, even finely polished smooth surfaces may exhibit grooves, ridges, and facets when viewed at the microscopic level. Materials in contact may deform temporarily at the point of contact to result in a larger contact area than a single line or point. As such, line contact between two surfaces may include one or more lines of such features on one surface making contact with one or more lines of such features on another surface, for example. Thus, the term “line contact” between two surfaces includes a single line in addition to a small localized area of a surface or a plurality of lines within a size of up to 1% of the surface area.

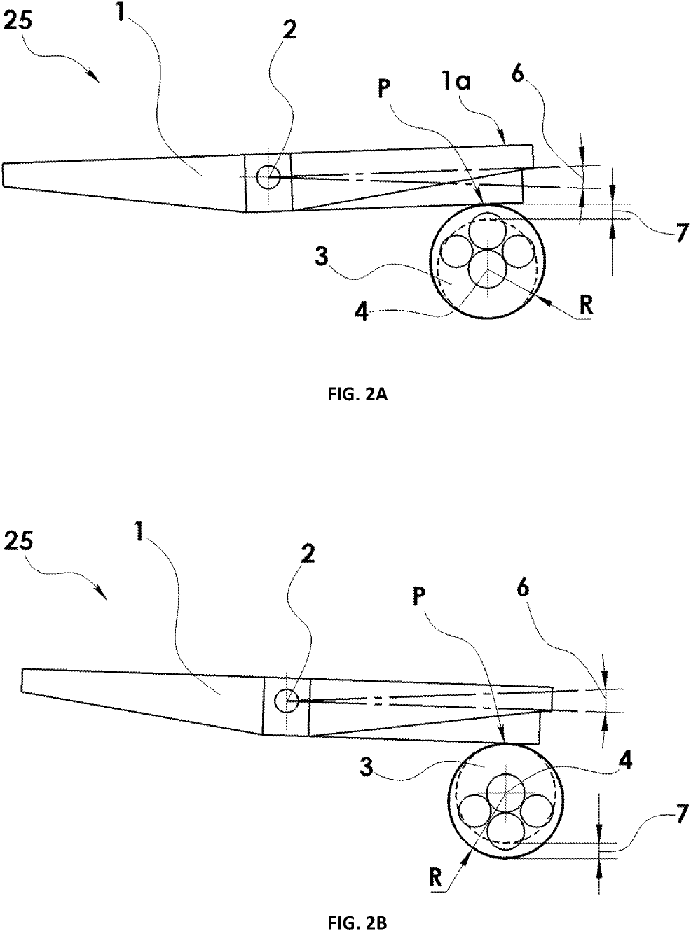

Side views in FIGS. 2A and 2B show components of a line scanner 25 with the mirror 1 and the cam 3 at its limits of travel, in accordance with embodiments of the present disclosure. In FIG. 2A, the cam 3 is rotated to move the first end 1a of the mirror 1 to a position of maximum vertical displacement, or first position. This first position results from the radius R, measured from the second rotational axis 4 of the cam 3 to the point of contact P, having its greatest value. In FIG. 2B, the cam 3 is rotated to move the first end 1a of the mirror 1 to a position of minimum vertical displacement, or second position. The second position can be achieved when the radius R of the cam 3 to the point of contact P has its smallest value. As shown in broken lines in FIGS. 2A-2B, a circle is superimposed over the cam 3 to illustrate its eccentric geometry, where the second rotational axis 4 passes through the center of the circle.

The angular difference between the mirror 1 orientation at these travel limits is the mechanical scanning angle 6 of the line scanner 25. The magnitude of the scanning angle 6 depends on the position of the cam axis 4 relative to the mirror axis 2 and the total runout of the cam profile 7. In some embodiments, the scanning angle 6 is from 0-10 degrees, including 0-5°, 1-10°, 2-8°, 2-5°, 5-10°, or other suitable value. In other embodiments, the scanning angle 6 is at least 5 degrees, including at least 7 degrees, at least 10 degrees, at least 15 degrees, or at least 20 degrees. As will be appreciated, the scanning angle 6 is governed, at least in part, by the geometry of the cam, where the practical speed of movement is limited by inertial forces acting on the mirror.

Scanning angle 6, scanning speed, and mirror size are interdependent in some practical embodiments and are limited by the magnetic force between the magnet 5 and the cam 3. For a mirror 1 of a given size, it is possible for a combination of scanning angle 6 and scanning speed to result in a separation force that is greater than the magnetic attraction force between the magnet 5 and the cam 3, thereby causing disengagement of the mirror 1 from the cam 3.

In one embodiment, such as for a scanning optical aperture of 25 mm, the line scanner 25 can have an optical scanning angle of 4 degrees and scanning speed, expressed as oscillation frequency, of ~500 Hz. In general, a larger aperture requires a larger moving mass of the mirror 1, reducing either the scanning speed or the scanning angle 6. Some embodiments of the present disclosure can have a flexible architecture that can be optimized to meet requirements of a particular application.

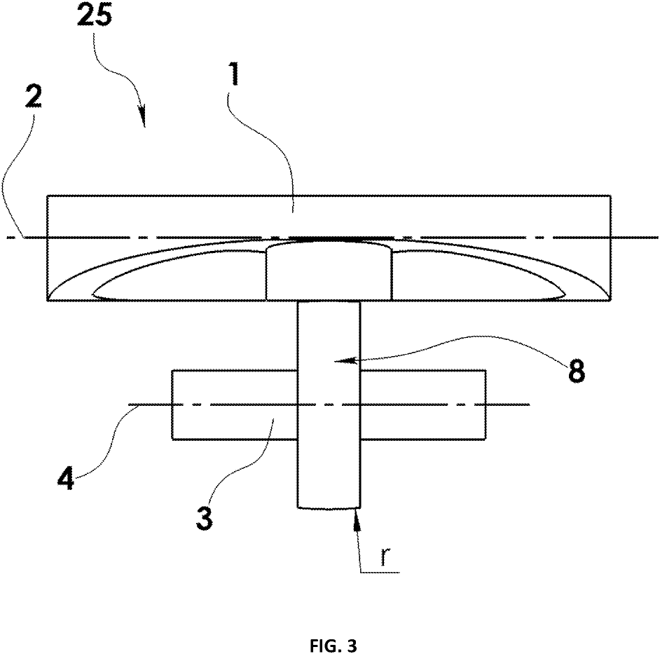

FIG. 3 illustrates a front view of a line scanner 25, in accordance with an embodiment of the present disclosure. In this example, the cam barrel 8 has a slight radius of curvature, r, to accommodate alignment tolerances between the first rotational axis 2 (of mirror 1) and the second rotational axis 4 (of cam 3). This rounded cam geometry and a planar surface of the cam follower (e.g., magnet 5) produce a point contact throughout the full range of cam rotation. If the misalignment between the mirror axis 2 and the cam axis 4 is eliminated, a flat cam barrel 8 profile that creates a line contact between the cam 3 and the follower (e.g., magnet 5) is possible.

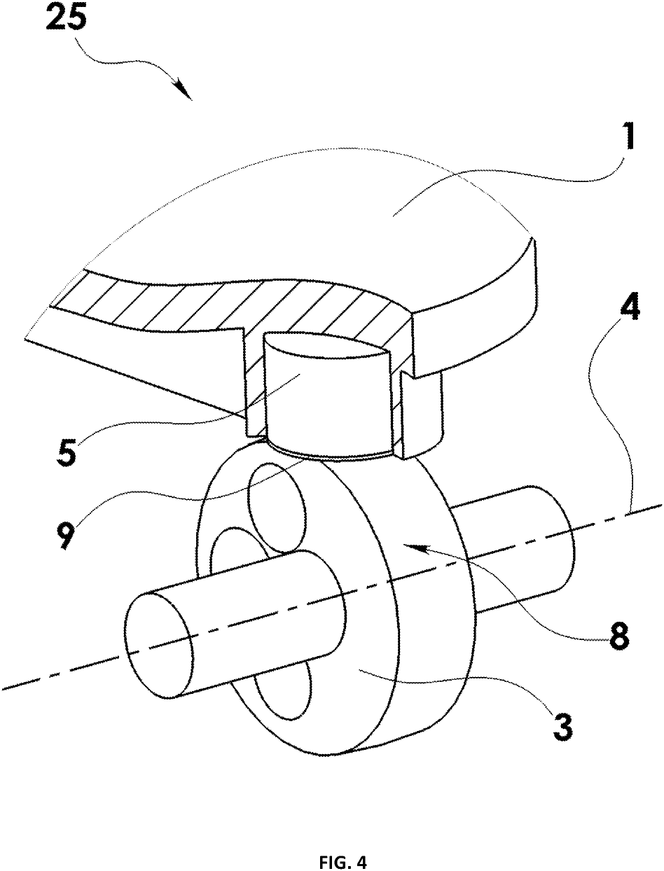

FIG. 4 illustrates a perspective view of a line scanner 25 with a bearing element 9 between the magnet 5 and the cam 3, in accordance with an embodiment of the present disclosure. In this example, the bearing element 9 becomes part of the follower assembly, making contact with the cam barrel 8 and reducing friction between the cam 3 and the follower (e.g., magnet 5). In this example, the bearing element 9 is a sapphire disk that is bonded to the magnet 5. The thickness of the bearing element 9 can be minimized in some embodiments to limit the reduction of the magnetic attraction force between the cam 3 and the magnet 5 of the follower. When the bearing element 9 is a sapphire disk, for example, the bearing element 9 can have a thickness of 100 µm - 150 µm, in accordance with some embodiments. In other embodiments, a titanium nitride (TiN) coating on the cam 3 and/or the magnet 5 can be used. Other bearing element 9 materials can be used, where the bearing element 9 is chosen to have a low coefficient of friction, a high hardness value, a high resistance to wear, a high compressive strength, a low thermal expansion coefficient, or a combination of these properties.

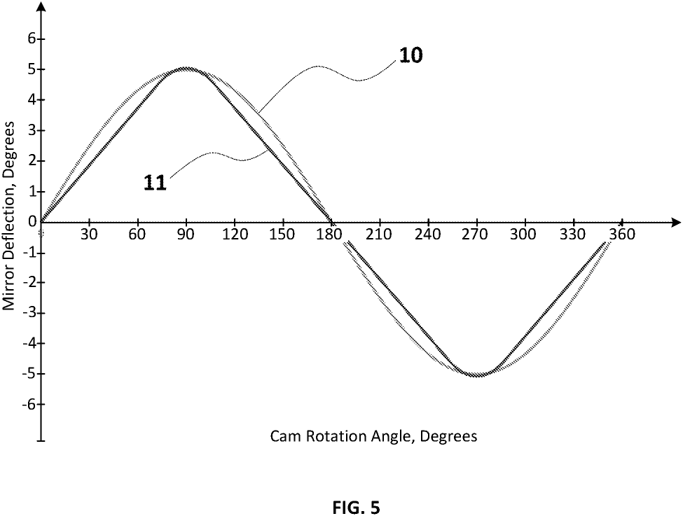

FIG. 5 depicts a plot of mirror deflection as a function of cam rotation angle for two typical scanning profile applications enabled by a line scanner of the present disclosure. The basic embodiment of the cam 3 can have a circular profile offset from the cam rotational axis 4, producing the sinusoidal mirror deflection 10. In other embodiments, the cam 3 profile can be calculated to offer linear regions to produce a mirror deflection profile 11 approximating a triangular wave, which is ideal for a majority of raster scanning applications.

### Further Example Embodiments

The following examples pertain to further embodiments, from which numerous permutations and configurations will be apparent.

Example 1 is a line scanner assembly comprising a cam with a cam surface, where the cam is rotatable about a cam axis of rotation and includes a ferromagnetic material. A follower is in contact with the cam surface and configured to tilt about a follower axis of rotation. A planar mirror is on the follower. The follower includes a permanent magnet. The follower maintains contact with the cam due to magnetic attraction between the cam and the follower.

Example 2 includes the subject matter of Example 1, where the follower makes point contact with the cam surface.

Example 3 includes the line scanner assembly of Example 2, where the cam surface is domed.

Example 4 includes the line scanner assembly of Example 1, where the follower makes line contact with the cam surface.

Example 5 includes the line scanner assembly of any one of Examples 1-4, where the permanent magnet contacts the cam surface.

Example 6 includes the line scanner assembly of any one of Examples 1-4 and includes a low-friction interface material on the follower, where the interface material makes contact with the cam surface.

Example 7 includes the line scanner assembly of Example 6, where the interface material is attached to the permanent magnet and is positioned between the permanent magnet and the cam.

Example 8 includes the line scanner assembly of any one of Examples 6-7, where the interface material comprises a sapphire disk.

Example 9 includes the line scanner assembly of Example 8, where the sapphire disk has a thickness from 100 µm to 150 µm.

Example 10 includes the line scanner assembly of any one of Examples 6-7, where the interface material comprises titanium nitride.

Example 11 includes the line scanner assembly of any one of Examples 1-10, where the assembly has a scanning angle of at least 10 degrees.

Example 12 includes the line scanner assembly of any one of Examples 1-11, where the assembly has a scanning oscillation frequency of at least 500 Hz.

Example 13 includes the line scanner assembly of any one of Examples 1-12, where the cam has a profile configured to oscillate the mirror with sinusoidal oscillation.

Example 14 includes the line scanner assembly of Example 13, where the cam is cylindrical and has an axis of rotation offset from a center of the cylindrical shape.

Example 15 includes the line scanner assembly of any one of Examples 1-12, where the cam has a profile configured to oscillate the mirror with oscillation approximating a triangle wave

Example 16 is a line scanner assembly comprising a cam with a cam surface, where the cam is rotatable about a cam axis of rotation and includes a first ferromagnetic material. A mirror having a planar surface is configured to tilt about a mirror axis of rotation. A follower is attached to the mirror and includes a second ferromagnetic material. The first magnetic material and/or the second magnetic material comprises a permanent magnet. The follower maintains contact with the cam due to a magnetic attraction between the first ferromagnetic material and the second ferromagnetic material.

Example 17 includes the line scanner assembly of Example 16, where the follower makes point contact with the cam surface.

Example 18 includes the line scanner assembly of Example 16 or 17, where the cam surface is domed.

Example 19 includes the line scanner assembly of Example 16, where the follower makes line contact with the cam surface.

Example 20 includes the line scanner assembly of any one of Examples 16-19, where the follower includes a permanent magnet in contact with the cam surface.

Example 21 includes the line scanner assembly of any one of Examples 16-20, where the follower includes an interface material on the follower, the interface material positioned between the follower and the cam surface.

Example 22 includes the line scanner assembly of Example 21, where the interface material comprises a sapphire disk.

Example 23 includes the line scanner assembly of Example 22, where the sapphire disk has a thickness from 100 µm to 150 µm.

Example 24 includes the line scanner assembly of any one of Examples 16-17, where the interface material comprises titanium nitride.

Example 25 includes the line scanner assembly of any one of Examples 16-24, where the assembly has a scanning angle range of at least 10 degrees.

Example 26 includes the line scanner assembly of any one of Examples 16-25, where the assembly has a scanning oscillation frequency of at least 500 Hz.

Example 27 includes the line scanner assembly of any one of Examples 16-26, where the cam has a profile configured to oscillate the mirror with sinusoidal oscillation.

Example 28 includes the line scanner assembly of Example 27, where the cam is cylindrical and has an axis of rotation offset from a center of the cylindrical shape.

Example 29 includes the line scanner assembly of any one of Examples 16-26, where the cam has a profile configured to oscillate the mirror with oscillation approximating a triangle wave.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

We claim:

1. A line scanner assembly comprising:
a cam with a cam surface, the cam rotatable about a cam axis of rotation and comprising a ferromagnetic material;
a follower in contact with the cam surface and configured to tilt about a follower axis of rotation, the follower comprising a permanent magnet; and
a planar mirror on the follower;
wherein the follower maintains contact with the cam due to magnetic attraction between the cam and the follower.

2. The line scanner assembly of claim 1, wherein the follower makes point contact with the cam surface.

3. The line scanner assembly of claim 2, wherein the cam surface is domed.

4. The line scanner assembly of claim 1, wherein the follower makes line contact with the cam surface.

5. The line scanner assembly of claim 1, further comprising an interface material on the follower, wherein the interface material makes contact with the cam surface.

6. The line scanner assembly of claim 5, wherein the interface material is attached to the permanent magnet between the permanent magnet and the cam.

7. The line scanner assembly of claim 5, wherein the interface material comprises a sapphire disk.

8. The line scanner assembly of claim 7, wherein the sapphire disk has a thickness from 100 µm to 150 µm.

9. The line scanner assembly of claim 5, wherein the interface material comprises titanium nitride.

10. The line scanner assembly of claim 1, wherein the assembly has a scanning angle range of at least 10 degrees and a scanning oscillation frequency of at least 500 Hz.

11. The line scanner assembly of claim 1, wherein the cam has a profile configured to oscillate the mirror with oscillation approximating a triangle wave.

12. A line scanner assembly comprising:
a cam with a cam surface, the cam rotatable about a cam axis of rotation and comprising a first ferromagnetic material;
a mirror with a planar surface, the mirror configured to tilt about a mirror axis of rotation; and
a follower attached to the mirror and comprising a second ferromagnetic material;
wherein the first magnetic material and/or the second magnetic material comprises a permanent magnet and wherein the follower maintains contact with the cam due to a magnetic attraction between the first ferromagnetic material and the second ferromagnetic material.

13. The line scanner assembly of claim 12, wherein the follower makes point contact with the cam surface.

14. The line scanner assembly of claim 13, wherein the cam surface is domed.

15. The line scanner assembly of claim 12, wherein the magnet assembly makes line contact with the cam surface.

16. The line scanner assembly of any of claim 12, further comprising an interface material on the follower, the interface material in contact with the cam surface.

17. The line scanner assembly of claim 16, wherein the interface material comprises a sapphire disk.

18. The line scanner assembly of claim 16, wherein the interface material comprises titanium nitride.

19. The line scanner assembly of claim 12, wherein the assembly has a scanning angle range of at least 10 degrees and a scanning oscillation frequency of at least 500 Hz.

20. The line scanner assembly of claim 19, wherein the cam has a profile configured to oscillate the mirror with oscillation approximating a triangle wave.
